(19) United States
(12) Patent Application Publication
(10) Pub. No.: US 2013/0115525 A1
(43) Pub. Date: May 9, 2013

(54) EXTERNAL PTFE LAYER REINFORCEMENT FOR OXIDANT ELECTRODE

(71) Applicants: Cody A. Friensen, Fort McDowell, AZ (US); Joel Hayes, Chandler, AZ (US); Kent Berchin-Miller, Gilbert, AZ (US)

(72) Inventors: Cody A. Friensen, Fort McDowell, AZ (US); Joel Hayes, Chandler, AZ (US); Kent Berchin-Miller, Gilbert, AZ (US)

(73) Assignee: Fluidic, Inc., Scottsdale, AZ (US)

(21) Appl. No.: 13/668,180

(22) Filed: Nov. 2, 2012

Related U.S. Application Data
(60) Provisional application No. 61/556,011, filed on Nov. 4, 2011.

(51) Int. Cl. H01M 12/06

(52) U.S. Cl. CPC H01M 12/06
USPC 429/403

(57) ABSTRACT

An oxidant electrode for an electrochemical cell utilizing a fuel electrode comprising a metal fuel and a liquid ionically conductive medium configured to conduct ions between the fuel electrode and the oxidant electrode to support electrochemical reactions at the fuel and oxidant electrodes, includes an active layer configured to participate in electrochemical reactions with the fuel electrode. The oxidant electrode also includes a solvophobic layer between an oxidant-facing side of the oxidant electrode, and the active layer. The solvophobic layer is configured to prevent permeation of the liquid ionically conductive medium therethrough, but permit permeation of a gaseous oxidant therethrough. The oxidant electrode further includes a reinforcement layer at the oxidant-facing side, configured to prevent a distortion of the solvophobic layer therethrough, towards the oxidant-facing side. The reinforcement layer is permeable to the gaseous oxidant.

This application claims the benefit of U.S. Provisional Application No. 61/556,011, filed Nov. 4, 2011, the content of which is incorporated in its entirety herein by reference.

### FIELD

The present invention is generally related to electrochemical cells, and more particularly to electrochemical cells utilizing a liquid ionically conductive medium.

### BACKGROUND

Many types of electrochemical cells utilize a liquid ionically conductive medium to support electrochemical reactions within the cell. For example, a metal-air electrochemical cell system may comprise a plurality of cells, each having a fuel electrode serving as an anode at which metal fuel is oxidized, and an air breathing oxidant electrode at which oxygen from ambient air is reduced. Such a cell may include the liquid ionically conductive medium to communicate the oxidized/reduced ions between the electrodes.

In some electrochemical cell systems utilizing a liquid ionically conductive medium, an air-permeable but liquid-impermeable membrane is utilized as part of the oxidant electrode, so as to permit the oxygen from the ambient air to enter the oxidant electrode, while preventing the liquid ionically conductive medium from escaping (i.e. leaking out of) the electrochemical cell. The air-permeable but liquid-impermeable membrane may be coupled to an active layer of the oxidant electrode, such that active materials in the active layer contact the liquid ionically conductive medium to facilitate electrochemical reactions within the cell. In some cases, the air-permeable but liquid-impermeable membrane may be laminated to the active layer and/or a current collector screen for the oxidant electrode.

In some cases, electrochemical cell systems utilizing such oxidant electrodes may encounter problems with blistering and/or peeling/delaminating of the air-permeable but liquid-impermeable membrane away from the remainder of the oxidant electrode. For example, one potential cause of the separation of the air-permeable but liquid-impermeable membrane may result from the pressure of a relatively large surface area of ionically conductive medium pressing against it. Polytetrafluoroethylene is a common material used for this membrane, and its lack of mechanical strength or structural rigidity through its thickness often permits blistering or bubbling to grow in an undesirable manner, leading to eventual failure of the membrane. Specifically, such failures may occur with a local separation of the membrane from the active layer. Such failures may also occur with a separation within the active layer local to the membrane interface, where the active layer is weaker than its bond to the membrane. It may be appreciated that such separations may cause the blistering, due to the lack of rigidity through the thickness of the oxidant electrode. Among other improvements, the present application endeavors to provide an effective and improved way of reinforcing the air-permeable but liquid-impermeable membrane, without adversely affecting the performance of the cell during operation.

### SUMMARY

According to an embodiment, an electrochemical cell includes (i) a fuel electrode comprising a metal fuel. The electrochemical cell also includes (ii) an oxidant electrode spaced from the fuel electrode, having a fuel electrode-facing side and an oxidant-facing side. The electrochemical cell further includes (iii) a liquid ionically conductive medium for conducting ions between the fuel and oxidant electrodes to support electrochemical reactions at the fuel and oxidant electrodes. The fuel electrode and the oxidant electrode are configured to, during discharge, oxidize the metal fuel at the fuel electrode and reduce a gaseous oxidant at the oxidant electrode to generate a discharge potential difference therebetween for application to a load. The oxidant electrode includes an active layer configured to participate in the electrochemical reactions at the oxidant electrode. The oxidant electrode also includes a solvophobic layer between the oxidant-facing side and the active layer, the solvophobic layer configured to prevent permeation of the liquid ionically conductive medium therethrough, but permit permeation of the gaseous oxidant therethrough. The oxidant electrode further includes a reinforcement layer at the oxidant-facing side, configured to prevent a distortion of the solvophobic layer therethrough, towards the oxidant-facing side, the reinforcement layer being permeable to the gaseous oxidant.

According to another embodiment, an oxidant electrode is for an electrochemical cell utilizing a fuel electrode comprising a metal fuel and a liquid ionically conductive medium configured to conduct ions between the fuel electrode and the oxidant electrode to support electrochemical reactions at the fuel and oxidant electrode. The oxidant electrode includes an active layer configured to participate in electrochemical reactions with the fuel electrode. The oxidant electrode also includes a solvophobic layer between an oxidant-facing side of the oxidant electrode, and the active layer. The solvophobic layer is configured to prevent permeation of the liquid ionically conductive medium therethrough, but permit permeation of a gaseous oxidant therethrough. The oxidant electrode futher includes a reinforcement layer at the oxidant-facing side, configured to prevent a distortion of the solvophobic layer therethrough, towards the oxidant-facing side. The reinforcement layer is permeable to the gaseous oxidant.

According to another embodiment, a method for assembling a reinforced oxidant electrode for an electrochemical cell includes providing a solvophobic layer configured to prevent permeation of a liquid ionically conductive medium therethrough, but permit permeation of a gaseous oxidant therethrough. The method also includes applying an active layer to a first side of the solvophobic layer facing the liquid ionically conductive medium. Theactive layer is configured to participate in electrochemical reactions at the oxidant electrode. The method further includes applying a reinforcement layer to a second side of the solvophobic layer facing the gaseous oxidant. The reinforcement layer is configured to prevent a distortion of the solvophobic layer therethrough, in a direction from the active layer to the reinforcement layer. The reinforcement layer is permeable to the gaseous oxidant.

Other aspects of the present invention will become apparent from the following detailed description, the accompanying drawings, and the appended claims.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIGS. 1A and 1B schematically illustrate embodiments of an electrochemical cell having a fuel electrode and an oxidant electrode, separated by a liquid ionically conductive medium configured to conduct ions therebetween;

FIG. 2 schematically illustrates a cross sectional view of an embodiment of the oxidant electrode of FIG. 1A or FIG. 1B;

FIG. 3 schematically illustrates a cross sectional view of another embodiment of the oxidant electrode of FIG. 1A or FIG. 1B;

FIG. 4 shows a simplified view of an embodiment of a reinforced solvophobic layer portion of the oxidant electrode of FIG. 1A or FIG. 1B; and

FIG. 5 shows a simplified view of another embodiment of a reinforced solvophobic layer portion of the oxidant electrode of FIG. 1A or FIG. 1B.

### DETAILED DESCRIPTION

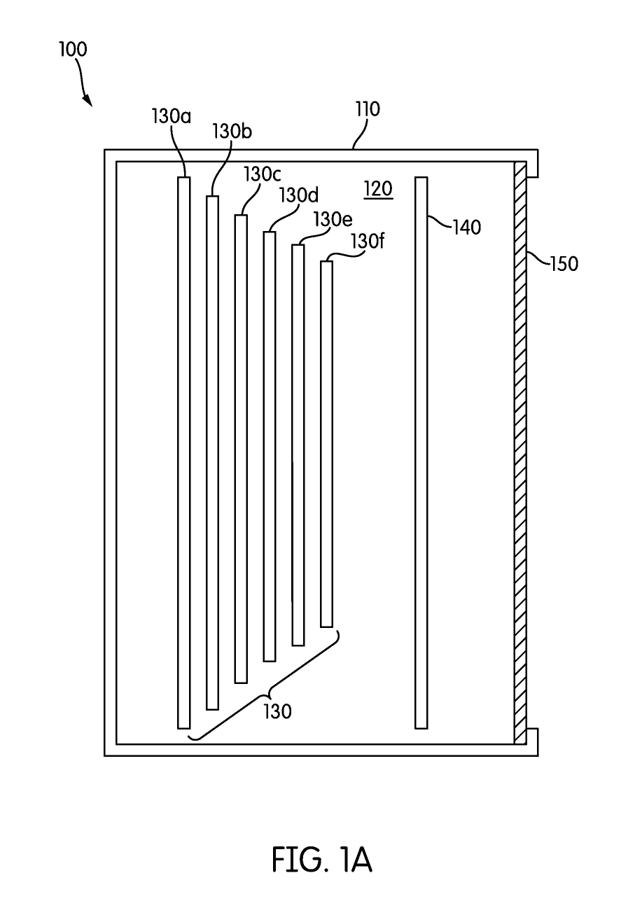

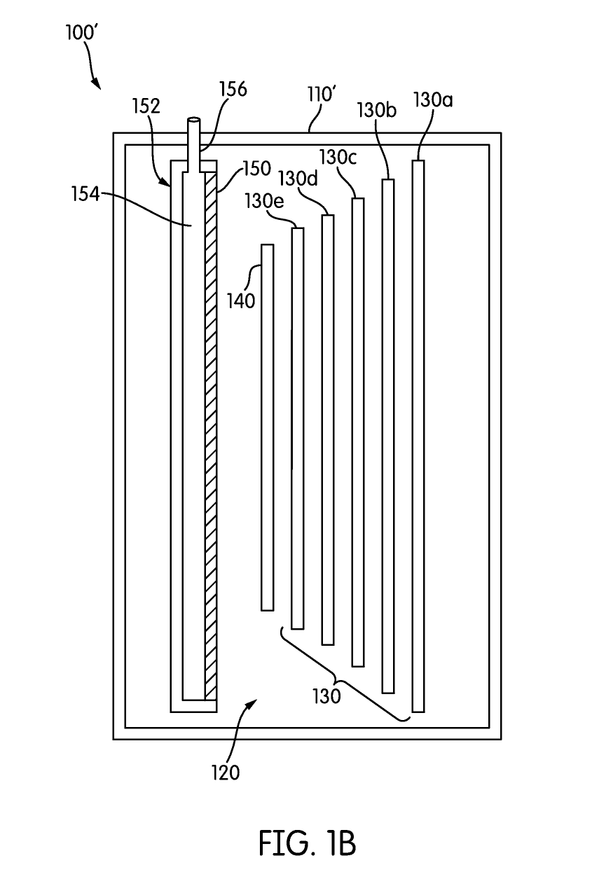

FIGS. 1A and 1B illustrate schematic views of embodiments of electrochemical cells having differing configurations. For example, FIG. 1A illustrates an electrochemical cell 100. As shown, the electrochemical cell 100 may be contained at least partially in a housing 110. Although the housing 110 is depicted as associated with a single electrochemical cell 100 in various embodiments, the housing may be shared by a plurality of cells 100, which in some embodiments may be electrically connected in either series or parallel. The cells 100, described in greater detail below, are configured to utilize a liquid ionically conductive medium that flows through or is otherwise contained in and/or constrained by portions of the housing 110, to conduct ions therein. The ionically conductive medium will also be described in greater detail below.

While in some embodiments the ionically conductive medium may be generally stationary within the housing 110, such as in a pool or other quantity of ionically conductive medium, in other embodiments the ionically conductive medium may be configured to flow into, through, and out of the electrochemical cell 100. In some embodiments, the ionically conductive medium may be stored in a reservoir, and a flow pump may be used to pump the ionically conductive medium through one or more electrochemical cells 100. In embodiments wherein the ionically conductive medium is flowing through the one or more cells 100, the rate of flow may vary in different embodiments. For example, in some embodiments, a constant flow of ionically conductive medium may be maintained, while in other embodiments the ionically conductive medium may be pulsed periodically through the cell. In some embodiments, sensors may be associated with the cell, and may provide signals (including but not limited to an indication of the passage of time, or an indication of a reduction of cell performance), which may prompt the flow pump to flow or pulse the ionically conductive medium. In some embodiments, including those where multiple cells 100 share a common flow of ionically conductive medium, one or more of the electrochemical cells 100 may contain therein one or more flow dispersers, such as is described in U.S. patent application Ser. No. 13/362,775, incorporated herein in its entirety by reference, which may disperse the ionically conductive medium to prevent shunt current from being conducted through the ionically conductive medium between cells 100.

It may be appreciated that joints or junctures in the housing 110 may be sealed together so as to contain the ionically conductive medium therein, or define a flow path therethrough. As such, in some embodiments a sealing material may be applied within the cell 100 to ensure liquid impermeability and prevent leakage. In various embodiments, the sealing material may comprise or include plastic or rubber gaskets, adhesives, or other sealants, including but not limited to solvent-bond sealants, single or two-part (i.e. base and accelerator) epoxies, or UV/thermally cured epoxies. In various embodiments, the sealants may comprise ABS cements, epoxies, or other sealants, including but not limited to those from one or more of Oatey, Weld-on, Eager Polymer, MagnaTac, Scotchweld, and Resinlab. Such sealants may be configured to prevent the undesirable loss of ionically conductive medium or flow pressure at the site where elements of the cell 100 join. In an embodiment, the sealing material may be non-conductive and electrochemically inert, to prevent interference with the electrochemical reactions of the cell 100.

The electrochemical cell 100 may be of any suitable structure or composition, including but not limited to being formed from plastic, metal, resin, or combinations thereof. Accordingly the cell 100 may be assembled in any manner, including being formed from a plurality of elements, being integrally molded, or so on. Embodiments including a flow of the ionically conductive medium through the cell 100 may differ in the structure and configuration of such flow, and those described herein are merely exemplary, and is not intended to be limiting in any way. For example, in various embodiments the cell 100 and/or the housing 110 may include elements or arrangements from one or more of U.S. patent application Ser. Nos. 12/385,217, 12/385,489, 12/549,617, 12/631,484, 12/776,962, 12/885,268, 12/901,410, 13/028,496, 13/083,929, 13/167,930, 13/185,658, 13/230,549, 13/299,167, 13/362,775, 13/526,432, 13/531,962, 13/532,374, 13/566,948, and 61/556,021, each of which are incorporated herein in their entireties by reference.

As shown in FIG. 1A, defined within the housing 110 of the cell 100 is a cell chamber 120 that is configured to house, which may include facilitating a defined flow therethrough, the ionically conductive medium. A fuel electrode 130 of the cell 100 may be supported in the cell chamber 120 so as to be contacted by the ionically conductive medium. In an embodiment, the fuel electrode 130 is a metal fuel electrode that functions as an anode when the cell 100 operates in discharge, or electricity generating, mode, as discussed in further detail below. As shown, in some embodiments the fuel electrode 130 may comprise a plurality of permeable electrode bodies 130a-130f Although in the illustrated embodiment six permeable electrode bodies 130a-130f are used, in other embodiments any number are possible. Each permeable electrode body 130a-130f may include a screen that is made of any formation that is able to capture and retain, through electrodepositing, or otherwise, particles or ions of metal fuel from the ionically conductive medium that flows through or is otherwise present within the cell chamber 120. In an embodiment, electrode body 130a may be a terminal electrode body, configured such that when charging, metal fuel may generally grow on the electrode bodies 130a-f in a direction defined from electrode body 130a towards electrode body 130f. Although in the illustrated embodiment, the permeable electrode bodies 130a-130f may have different sizes so that a stepped scaffold configuration may be used, as described by U.S. patent application Ser. No. 13/167,930, incorporated by reference above, in other embodiments the permeable electrode bodies 130a-130f may have substantially the same size.

In some embodiments, a plurality of spacers may separate the permeable electrode bodies 130a-130f so as to create flow lanes in the fuel electrode 130. The plurality of spacers may be connected to the housing 110 so that the fuel electrode 130 may be held in place relative to the housing 110. In some such embodiments, the spacers may be non-conductive and electrochemically inert so they are inactive with regard to the electrochemical reactions in the cell 100. In some embodiments, the spacers may be made from a suitable plastic material, such as polypropylene, polyethylene, polyester, noryl, ABS, fluoropolymer, epoxy, or so on. The flow lanes in the fuel electrode 130 may be three-dimensional, and have a height that is substantially equal to the height of the spacers. The spacers are optional and may be omitted in some embodiments.

In some embodiments of the cell 100, such as that illustrated, a charging electrode 140 may be positioned spaced from the fuel electrode 130, distal from the terminal electrode body 130a (i.e. proximal to the electrode body 130f). In some embodiments, the charging electrode 140 may be a portion of the fuel electrode 130 (including, for example, being one or more of the permeable electrode bodies 130b-130f). As with the fuel electrode 130, the charging electrode 140 may be positioned within the cell chamber 120, so as to be in contact with the ionically conductive medium. In some embodiments, such as that shown, the charging electrode 140 may extend at least as far as the longest of the permeable electrode bodies 130a-f, when those electrode bodies 130a-f are in a stepped scaffold configuration, or otherwise vary in size. As described in greater detail below, the charging electrode 140 may be configured to participate in the oxidation of an oxidizable reductant species and the reduction of an oxidized metal fuel species, both of which being present in the liquid ionically conductive medium, so as to promote the growth of metal fuel on the fuel electrode 130 during charging of the cell 100.

Further shown in FIG. 1A is an oxidant electrode 150, which is spaced from the fuel electrode 130 and the charging electrode 140, distal from the terminal electrode body 130a. As shown, in embodiments containing the separate charging electrode 140, the separate charging electrode 140 is positioned between the oxidant electrode 150 and the fuel electrode 130. In embodiments of the cell 100 lacking the separate charging electrode 140, the oxidant electrode 150 may be utilized both during charging and discharging of the cell 100 (i.e. as an anode during charging and as a cathode during discharging).

In the illustrated embodiment of FIG. 1A, the oxidant electrode 150 defines a boundary wall for the cell chamber 120, and is sealed to a portion of the housing 110 so as to prevent seepage of ionically conductive medium therebetween. It may be appreciated, however, in some embodiments the oxidant electrode 150 may be immersed into the ionically conductive medium. For example, FIG. 1B depicts such an embodiment, whereby cell 100′ contains a housing 110′ that is formed from a plurality of sidewalls and a bottom, such that the oxidant electrode 150 is immersed within the housing 110′, instead of forming one of the sidewalls that contain the ionically conductive medium. In particular, the oxidant electrode 150 is coupled to or otherwise installed in an oxidant electrode module 152, which are jointly immersed into the housing 110′. The oxidant electrode module 152 and the oxidant electrode 150 together define an air space 154 therebetween that allows an oxidizer to be exposed to the air side of the oxidant electrode 150. As shown, one or more air channels 156 may be provided so as to permit a supply of oxidizer into the air space 154 immersed into the ionically conductive medium. Additional details of one such embodiment are described in U.S. patent application Ser. No. 13/531,962, incorporated in its entirety above by reference.

Although in some embodiments the oxidizer may be delivered to the oxidant electrode 150 by a passive system, which may be sufficient to allow diffusion or permeation of oxygen from the air (i.e. in the air space 154) into the oxidant electrode 150, in other embodiments different sources of the oxidizer or mechanisms for bringing the oxidizer to the oxidant electrode may be utilized. For example, in an embodiment, a pump such as an air pump may be used to deliver the oxidizer into or through the air space 154 to supply the oxidant electrode 150 under pressure. The air pump may be of any suitable construction or configuration, including but not limited to being a fan or other air movement device configured to produce a constant or pulsed flow of air or other oxidant. The oxidizer source may be a contained source of oxidizer. In an embodiment, oxygen may be recycled from the electrochemical cell module 100, such as is disclosed in U.S. patent application Ser. No. 12/549,617, previously incorporated by reference above. Likewise, when the oxidizer is oxygen from ambient air, the oxidizer source may be broadly regarded as the delivery mechanism, whether it is passive or active (e.g., pumps, blowers, etc.), by which the air is permitted to flow to the oxidant electrode 150. Thus, the term “oxidizer source” is intended to encompass both contained oxidizers and/or arrangements for passively or actively delivering oxygen from ambient air to the oxidant electrode 150.

Besides for the positioning and orientation of the oxidant electrode 150, however, it may be appreciated that the cell 110′ may generally be otherwise similar to the cell 100. As such, reference to components of the cell 100 may apply equally or with minor modification to the cell 100′. For example, in some embodiments, one or more components of the cell 100, such as the fuel electrode 130, the permeable electrode bodies 130a-f thereof, and/or the separate charging electrode 140, may be of any suitable construction or configuration, including but not limited to being constructed of Nickel or Nickel alloys (including Nickel-Cobalt, Nickel-Iron, Nickel-Copper (i.e. Monel), or superalloys), Copper or Copper alloys, brass, bronze, or any other suitable metal, including plated metals, such as nickel-plated copper. The construction and configuration of the oxidant electrode 150 is a subject of the present application, and is described in greater detail below. It may be appreciated, however, that in various embodiments one or more materials in the cell 100, into which the oxidant electrode 150 is installed, may differ.

The fuel used in the cell 100 may be a metal, such as iron, zinc, aluminum, magnesium, or lithium. By metal, this term is meant to encompass all elements regarded as metals or semi-metals on the periodic table, including but not limited to alkali metals, alkaline earth metals, lanthanides, actinides, post-transition metals and transition metals, either in atomic, molecular (including metal hydrides), or alloy form when collected on the electrode body. However, the present invention is not intended to be limited to any specific fuel, and others may be used. The fuel may be provided to the cell 100 as particles suspended in the ionically conductive medium. In some embodiments, a metal hydride fuel may be utilized in cell 100.

The ionically conductive medium may be an aqueous solution. Examples of suitable mediums include aqueous solutions comprising sulfuric acid, phosphoric acid, triflic acid, nitric acid, potassium hydroxide, sodium hydroxide, sodium chloride, potassium nitrate, or lithium chloride. In some embodiments, the ionically conductive medium is aqueous potassium hydroxide. In an embodiment, the ionically conductive medium may comprise an electrolyte. For example, a conventional liquid electrolyte solution may be used, or a room temperature ionic liquid may be used, as mentioned in U.S. patent application Ser. Nos. 12/776,962 and 13/526,432, previously incorporated by reference above. In some embodiments, additives may be added to the ionically conductive medium, including, but not limited to additives which enhance the electrodeposition process of the metal fuel on the fuel electrode 130, such as is described in U.S. patent application Ser. No. 13/028,496, previously incorporated by reference above. Such additives may reduce the loose dendritic growth of fuel particles, and thus the likelihood of such fuel particles separating from the fuel electrode 130, for example.

In operation of the cell 100, the fuel may be oxidized at the fuel electrode 130 when the fuel electrode 130 is operating as an anode, and an oxidizer, such as oxygen, may be reduced at the oxidant electrode 150 when the oxidant electrode 150 is operating as a cathode, which is when the cell 100 is connected to a load and the cell 100 is in discharge or electricity generation mode, as discussed in further detail below. The reactions that occur during discharge mode may generate by-product precipitates, e.g., a reducible fuel species, in the ionically conductive medium. For example, in embodiments where the fuel is zinc, zinc oxide may be generated as a by-product precipitate/reducible fuel species. The oxidized zinc or other metal may also be supported by, oxidized with or solvated in the electrolyte solution, without forming a precipitate (e.g. zincate may be a dissolved reducible fuel species remaining in the fuel). During a recharge mode, the reducible fuel species, e.g. zinc oxide, may be reversibly reduced and deposited as the fuel, e.g., zinc, onto at least a portion of the fuel electrode 130 that functions as a cathode during recharge mode. During recharge mode, either the oxidant electrode 150 or the separate charging electrode 140, and/or another portion of the fuel electrode 130, as described below, functions as the anode.

Although in some embodiments the oxidizer may be delivered to the oxidant electrode 150 by a passive system, which may be sufficient to allow diffusion or permeation of oxygen from the air into the oxidant electrode 150, in other embodiments different sources of the oxidizer or mechanisms for bringing the oxidizer to the oxidant electrode may be utilized. For example, in an embodiment, a pump such as an air pump may be used to deliver the oxidizer to the oxidant electrode 150 under pressure. The air pump may be of any suitable construction or configuration, including but not limited to being a fan or other air movement device configured to produce a constant or pulsed flow of air or other oxidant. The oxidizer source may be a contained source of oxidizer. In an embodiment, oxygen may be recycled from the electrochemical cell 100′, such as is disclosed in U.S. patent application Ser. No. 12/549,617, previously incorporated by reference above. Likewise, when the oxidizer is oxygen from ambient air, the oxidizer source may be broadly regarded as the delivery mechanism, whether it is passive or active (e.g., pumps, blowers, etc.), by which the air is permitted to flow to the oxidant electrode 150. Thus, the term “oxidizer source” is intended to encompass both contained oxidizers and/or arrangements for passively or actively delivering oxygen from ambient air to the oxidant electrode 150.

In various embodiments, the permeable electrode bodies 130a-f, the separate charging electrode 140, and the oxidant electrode 150 may be connected by a switching system that may be configured to connect the cell 100 to a power supply, a load, or other cells 100 in series. During discharge, the fuel electrode 130 is connected to the load, and operates as an anode so that electrons given off by the metal fuel, as the fuel is oxidized at the fuel electrode 130, flows to the external load. The oxidant electrode 150 functions as the cathode during discharge, and is configured to receive electrons from the external load and reduce an oxidizer that contacts the oxidant electrode 150, specifically oxygen in the air surrounding the cell 100, oxygen being fed into the cell 100, or oxygen recycled from the cell 100.

The operation of the switching system may vary across embodiments, and in some embodiments the operation may be similar to those described in U.S. patent application Ser. No. 13/299,167, incorporated above by reference. As another example, in an embodiment, the external load may be coupled to some of the permeable electrode bodies 130a-130f in parallel, as described in detail in U.S. patent application Ser. No. 12/385,489, incorporated above by reference. In other embodiments, the external load may only be coupled to the terminal permeable electrode body 130a, distal from the oxidant electrode 150, so that fuel consumption may occur in series from between each of the permeable electrode bodies 130a-130f. In some embodiments, the cell 100 may be configured for charge/discharge mode switching, as is described in U.S. patent application Ser. No. 12/885,268, filed on Sep. 17, 2010, previously incorporated by reference above.

In some embodiments, one or more of the electrode bodies 130a-f, the oxidant electrode 150 and/or the charging electrode 140 may be interconnected by the switching system, or any other circuit, so as to selectively facilitate control of the charging and discharging of the cell 100. Switches associated with the switching system may be controlled by a controller, which may be of any suitable construction and configuration, including but not limited to, in some embodiments, conforming generally to those disclosed in U.S. application Ser. Nos. 13/083,929, 13/230,549, and 13/299,167, incorporated by reference above. In various embodiments, the control of the switches of the switching system may be determined based on a user selection, a sensor reading, or by any other input. In some embodiments, the controller may also function to manage connectivity between the load and the power source and a plurality of the cells 100. In some embodiments, the controller may include appropriate logic or circuitry for actuating bypass switches associated with each cell 100 in response to detecting a voltage reaching a predetermined threshold (such as drop below a predetermined threshold).

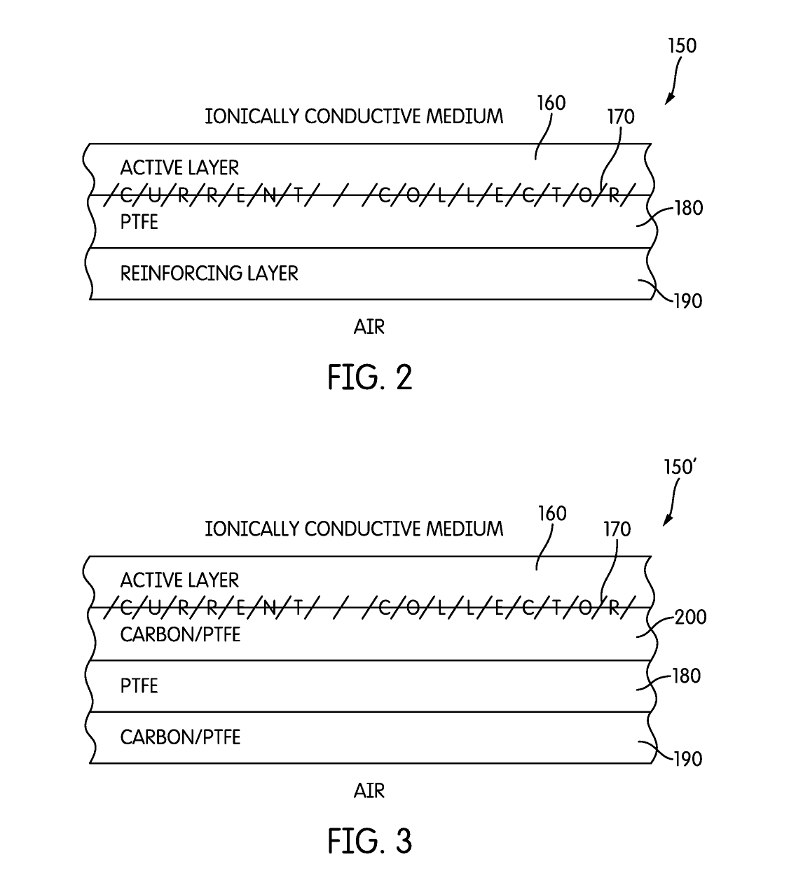

As noted above, the structure and configuration of embodiments of the oxidant electrode 150 are subjects of the present application. Shown in FIG. 2 is a schematic cross sectional view of an embodiment of the oxidant electrode 150. As shown, in an embodiment the oxidant electrode 150 contains a plurality of layers, each of which may be configured to provide certain features for the oxidant electrode 150 as a whole. For example, FIG. 2 shows that the oxidant electrode 150 contains an active layer 160, which may contain those elements of the oxidant electrode 150 that provide for oxygen reduction in the electrochemical cell 100. In an embodiment, the active layer may include catalysts, supported catalysts, and binders that may be characterized as active materials. The active materials serve to create a potential difference between the oxidant electrode and the fuel electrode when the cell is connected to a load. In an embodiment, the active layer may be used to create a potential difference between the oxidant electrode 150 and the fuel electrode 130, when the cell 100 is connected to the load. In an embodiment, the materials of the oxidant electrode 150 that create the potential difference with the fuel electrode 130 may be characterized as the “active material(s).” Accordingly, the oxidant electrode 150 is positioned in the cell housing 110 such that the active layer 160 (and the active materials therein) faces the cell chamber 120 and contacts the ionically conductive medium, whereby ions may be conducted through the ionically conductive medium to and/or from the fuel electrode 130, as described above. In some embodiments, the active materials of the active layer 160 may be formed by a mixture of catalyst particles or materials, conductive matrix and solvophobic materials, sintered, layered, or otherwise bonded to form a composite material. In various embodiments the active layer 160 may be of any suitable construction or configuration, including but not limited to being constructed of carbon, fluoropolymers such as PTFE, PFA, FEP, and/or PVDF, epoxies, graphite, nickel, activated carbons, fibers such as PTFE, PP, PE, SiO₂ (glass), or Al₂O₃, or any other suitable metal or alloy. In some embodiments the active layer contains a catalyst for promoting the reduction of oxygen. This catalyst can be incorporated as independent particles or be supported on a conductive substrate, such as carbon black, activated carbon, or graphite, or other common catalysts such as Pt, Pt alloys, MnO₂, silver, and perovskites. In some embodiments, the oxidant electrode may also be a bifunctional electrode (i.e. it may have the ability to perform both oxygen reduction and oxygen evolution functions), thereby obviating the need for a separate charging electrode.

Electrically coupled to the active layer 160 may be a current collector 170, which may be configured to receive electrons from a load for consumption by the oxidant reduction reaction when the cell 100 is in a discharge mode. Likewise, the current collector 170 may be configured to collect electrons from the oxidation reaction at the active layer 160 (i.e. when the oxidant electrode 150 serves as the charging electrode) for delivery to the power supply, to participate in the electrochemical reactions at the active layer 160, when the cell 100 is in a charging mode. The current collector 170 may be of any appropriate construction or configuration, including but not limited to being a metal screen. It may be appreciated that the current collectors 170 conventionally have holes therein that are on the order of 50-2500 μm, but are preferably in the range of 100-1000 μm, and may in some embodiments be uniformly dispersed across its area. These holes serve to increase the area of the current collector to more efficiently distribute or collect electrons, and also allow the transport of gaseous oxidant and/or ionic transport of reduced oxidant species. Thus, products and reactants can be communicated through the holes to either the ionically conductive medium or the ambient environment. In various embodiments the current collector 170 may be constructed of metals or alloys such as but not limited to those described above for the fuel electrode 130.

As shown in FIG. 2, the current collector 170 may be positioned within or between the active layer 160 and a solvophobic layer 180, described in greater detail below. In some embodiments, the current collector 170 may be at least partially embedded within the active materials of the active layer 160. In some embodiments, the current collector 170 may be partially embedded into the solvophobic layer 180. The current collector 170 preferably does not penetrate through the solvophobic layer 180, as its surface is typically not hydrophobic and thus presents a leak path for the ionically conductive medium if it penetrates the solvophobic layer.

The solvophobicity of the solvophobic layer materials may also be negatively impacted by permeation of the ionically conductive medium therethrough. This can occur by communicating a potential to the solvophobic layer while it is simultaneously exposed to the ionically conductive medium, causing electrowetting. Potentials applied to conductive porous layers can drive electrowetting, leading to leakage and loss of electrolyte. Electrowetting accelerates the rate at which electrolyte permeates a pore. The active layer 160 is, by definition, conductive. Given that the solvophobic layer 180 is non-conductive, and that the reinforcing layer 190 may be conductive and constructed such that it functions as a secondary solvophobic layer, if the reinforcing layer 190 is electrically isolated from the current collector 170 and the active layer 160, its secondary solvophobic properties will be augmented because it will not be subject to electrowetting.

As indicated above, the oxidant electrode 150 may be configured to contain the ionically conductive medium within the cell housing 110, or may otherwise be configured to maintain an air space associated with the oxidant electrode 150. The oxidant electrode 150 as a whole may therefore be liquid impermeable, yet air permeable, such that air may enter the cell 100 and permeate into the active layer 160, so as to serve as the oxidant during the electrochemical reactions taking place during discharge of the cell 100, between the active materials of the oxidant electrode 150 and the fuel electrode 130. In an embodiment, as the active layer 160 may be configured to permit at least partial permeation of the ionically conductive medium therein, the liquid-impermeability of the oxidant electrode 150 may be at least partially provided by the solvophobic layer 180. In some embodiments, the solvophobic layer 180 may be an air permeable yet liquid impermeable membrane. Accordingly, in various embodiments, the solvophobic layer 180 may be of any suitable construction or configuration that facilitates supporting the active materials thereon, is air permeable to facilitate permeation of the oxidant therethrough, yet liquid impermeable so as to prevent permeation of the ionically conductive medium out of the cell 100, or into the air space 154 associated with the immersed oxidant electrode 150 in the cell 100′.

Although the solvophobic layer 180 may vary across embodiments, in some embodiments the solvophobic layer 180 may be constructed of or otherwise include a fluoropolymer. As an example, in various embodiments, the solvophobic layer 180 may comprise polytetrafluoroethylene (also known as PTFE, or Teflon®), which may in some embodiments be thermo-mechanically expanded (also known as ePTFE, or Gore-Tex®). In other embodiments, the solvophobic layer 180 may comprise Fluorinated Ethylene Propylene (also known as FEP), or any other fluoropolymer. In some embodiments, the solvophobic layer 180 may have a fine pore size, such as but not limited to on the order of less than 1 micrometer. In some embodiments, for example, the pore size of the solvophobic layer 180 may be on the order of approximately 50 to 200 nanometers. It may be appreciated that in some embodiments the solvophobic layer 180 may have limited mechanical integrity (i.e., rigidity) through the thickness of the layer. As indicated above, failure resulting from this limited mechanical integrity may typically be due to local active layer/membrane interfacial delamination, causing blistering that may expand and propagate due to inherent flexibility of the membrane. Accordingly, for reasons such as due to the pressure of the ionically conductive medium on the oxidant electrode 150, there may in some cases be a tendency for the solvophobic layer 180 to distort, such as by blistering or peeling away from the active layer 160 and/or the current collector 170 (i.e., towards the air space of the oxidant electrode 150 when it is immersed, or towards the exterior of the cell 100). This is particularly an issue with PTFE films.

As shown in FIG. 3, to support the solvophobic layer 180, a reinforcement layer 190 is provided on the air side of the oxidant electrode 150, and may assist in distributing the fluid pressure of the ionically conductive medium on the oxidant electrode 150. Accordingly, to facilitate the transmission of oxidant to the active materials of the active layer 160, the reinforcement layer 190 is air-permeable. In some embodiments the reinforcement layer 190 may additionally be liquid-impermeable, which may provide redundancy to the solvophobic layer 180 to prevent leakage of ionically conductive medium through the oxidant electrode 150. Although the construction of the reinforcement layer 190 may vary across embodiments, it may be appreciated that while the reinforcement layer 190 is of sufficient porosity to facilitate air-permeability, the size of gaps or pores do not necessarily have to be small enough to be liquid impermeable to the ionically conductive medium. The pore size, if any, should be small enough to prevent blistering or peeling/delaminating of portions of the solvophobic layer 180 therethrough. For example, in some embodiments, the porosity of the reinforcement layer 190 may be less than 1 micrometer, such as, for example, between 50 and 200 nanometers. In some embodiments, the pore size of the reinforcement layer 190 may be slightly smaller than that of the solvophobic layer 180. In other embodiments, the pore size of the reinforcement layer 190 may be approximately the same size as the solvophobic layer 180. In still other embodiments, the pore size of the reinforcement layer 190 may be slightly larger than that of the solvophobic layer 180, however may be sufficiently small to prevent blistering or peeling/delaminating of the solvophobic layer 180 therethrough. It may be appreciated that the reinforcement layer 190 may improve upon the mechanical properties of the membrane by acting as a rigid support through the thickness of the oxidant electrode 150.

Although the material composition of the reinforcement layer 190 may vary across embodiments, in some embodiments the reinforcement layer 190 may comprise a combination of binder and reinforcement members. For example, in some embodiments the binder may comprise a fluoropolymer, including but not limited to PTFE, ePTFE, PVDF, PFA, FEP, polypropylene, polyethylene, and/or epoxy particles and fibers. In some embodiments, the binder may contain multiple types of materials, including multiple types of fluoropolymer. In various embodiments, the reinforcement members may be particles, fibers, or other morphologies that in combination with the binder achieve air permeability, yet be of sufficient strength to reinforce the solvophobic layer 180. In various embodiments, the reinforcement members may comprise materials such as carbon, alumina, or other durable materials, such that the reinforcement material forms a sufficiently small pore size as described above. For example, in some embodiments, the reinforcement member may comprise carbon fibers, alumina fibers, or other such fibers (including but not limited to other durable fibers), whereby ligaments of fiber are spaced at approximately a sub-micron level. In some embodiments, the binder itself may comprise a durable material interlaced with fibers of air-permeable material, such that the combination is air-permeable yet sufficient to reinforce the solvophobic layer 180. For example, in one non-limiting embodiment, the reinforcement layer 190 may comprise fibers or particles of fluoropolymer in carbon, with sufficient spacing to be air permeable. In some embodiments the reinforcement layer may include a composite material formed by pressurization and sintering of a mixture that includes air permeable-binder material (i.e., PTFE), with particles or fibers having high mechanical strength (i.e., carbon). In some embodiments, the reinforcement layer 190 may contain approximately 25-75% by volume of the binder, with some or all of the balance being the reinforcement material.

Turning to FIG. 3, another embodiment of the oxidant electrode 150, namely an oxidant electrode 150′, is depicted in a cross sectional view. As with the oxidant electrode 150, the oxidant electrode 150′ contains therein the active layer 160, which contains the active materials configured to contact the ionically conductive medium and participate in the electrochemical reactions between the oxidant electrode 150′ and the fuel electrode 130. As additionally shown, the current collector 170 is also provided, and contacts the active layer 160 so as to facilitate transmission of electrons produced in the electrochemical reactions to the load when the cell 100 is in a discharge mode. Conversely, the current collector 170 may also accumulate electrons from the power supply for the active layer 160 to engage in the electrochemical reactions when the cell 100 is being recharged (i.e. in embodiments where the oxidant electrode 150′ serves as the charging electrode 140). As further shown, proximal to the air side of the oxidant electrode 150′ is again the solvophobic layer 180 and the reinforcement layer 190. In the illustrated embodiment of oxidant electrode 150′, the reinforcement layer 190 comprises bonded particles of carbon and a fluoropolymer binder.

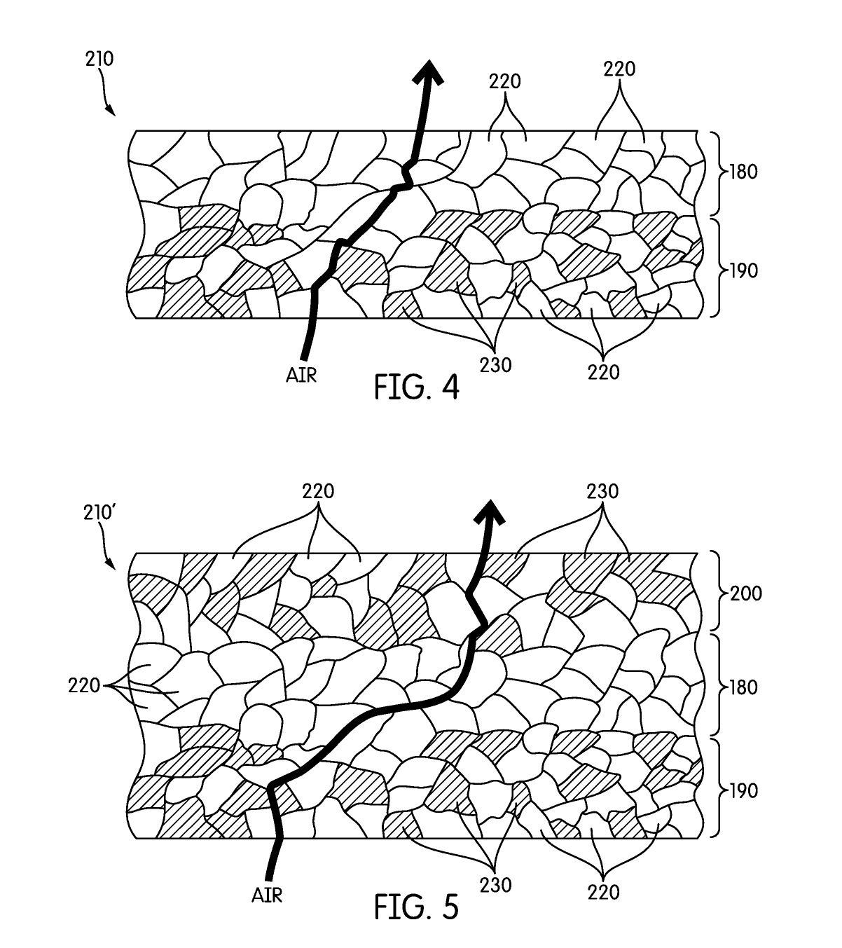

Added to the embodiment of oxidant electrode 150′, however, is a secondary reinforcement layer 200, which together with reinforcement layer 190 is configured to surround the solvophobic layer 180. In an embodiment, the secondary reinforcement layer 200 may be of a similar composition as the reinforcement layer 190. For example, in the illustrated embodiment, where the reinforcement layer 190 comprises bonded particles of carbon and fluoropolymer binder, the secondary reinforcement layer 200 may also comprise bonded particles of carbon and fluoropolymer binder. In other embodiments, however, the reinforcement layer 190 and the secondary reinforcement layer 200 may be of differing compositions. The secondary reinforcement layer 200 may be a hydrophobic, solvophobic, and electrically conductive layer that bonds to both the active layer and the PTFE membrane so as to prevent blistering and delamination at the active layer/membrane interface. Although the layers of the oxidant electrodes 150, 150′ are shown in FIG. 2 and FIG. 3 as being discrete layers, it may be appreciated that in some embodiments the layers may be at least partially formed together. For example, as is shown in FIG. 4, in some embodiments the solvophobic layer 180 and the reinforcement layer 190 may be assembled together as a reinforced solvophobic layer 210, from different concentrations of an air-permeable solvophobic binder 220 and a reinforcement material 230. As shown in the greatly exaggerated and simplistic view, the solvophobic layer 180 may be the portion of the reinforced solvophobic layer 210 having a greater concentration of solvophobic binder 220, while the reinforcement layer 190 of the reinforced solvophobic layer 210 may have a sufficient concentration of reinforcement material 230 therein. For example, while the solvophobic layer 180 may be comprised generally entirely of solvophobic binder 220, the reinforcement layer 190 may contain between approximately 25-75% by volume of solvophobic binder 220, with the balance generally being the reinforcement material 230. Similarly, in FIG. 5, another embodiment of the reinforced solvophobic layer 210 is provided (as reinforced solvophobic layer 210′), which is similar to reinforced solvophobic layer 210, however contains a concentration of reinforcement material 230 in the solvophobic binder 220 on either side of the concentration of solvophobic binder 220 forming the solvophobic layer 180, so as to form both the reinforcement layer 190 and the secondary reinforcement layer 200. For example, while the solvophobic layer 180 of the reinforced solvophobic layer 210′ may be comprised generally entirely of solvophobic binder 220, the reinforcement layer 190 and/or the secondary reinforcement layer 200 may each contain between approximately 25-75% by volume of solvophobic binder 220, with the balance generally being the reinforcement material 230. As may be appreciated from the exaggerated views of FIGS. 4 and 5, while the solvophobic binder 220 and the reinforcement material 230 are intermingled and adjacent to one another, the air permeability and liquid impermeability thereof may generally be attributed to spacing between the particles at a microscopic level, whereby the gas may permeate through the reinforced solvophobic layer 210, however the ionically conductive medium generally cannot.

As indicated above, conduction of electricity across the solvophobic layer 180 may result in electrowetting of the solvophobic layer 180, which may promote loss of ionically conductive medium from the cell 100. As indicated above, it is for such reasons that current collector 170 preferably does not permeate through the solvophobic layer 180 to the air side of the oxidant electrode 150 (or oxidant electrode 150′). Accordingly, in an embodiment, care may be taken to ensure that the reinforcement layer 190, on the air side of the solvophobic layer 180, is electrically isolated from the active layer 160 and the current collector 170. Accordingly, it may be appreciated that the solvophobic layer 180 may prevent electrical conduction through the oxidant electrodes 150, 150′. At the edges of the oxidant electrodes 150, 150′, the constituent layers may be crimped and glued to combine them into the air-permeable yet liquid impermeable assemblies of the oxidant electrodes 150 or 150′. Accordingly, care may be taken to prevent inadvertent contact at the edges of the oxidant electrodes 150, 150′ between the reinforcement layer 190 and any of the secondary reinforcement layer 200, the active layer 160, and the current collector 170. As one non-limiting example, in an embodiment the non-conductive solvophobic layer 180 may be generally longer than the other layers, and may be partially wrap around the edges of the active layer 160 and the current collector 170, so as to prevent their contact with the reinforcement layer 190 when the edges of the oxidant electrodes 150, 150′ are crimped.

The foregoing illustrated embodiments have been provided solely for illustrating the structural and functional principles of the present invention and are not intended to be limiting. For example, the present invention may be practiced using different fuels, different oxidizers, different electrolytes, and/or different overall structural configuration or materials. Thus, the present invention is intended to encompass all modifications, substitutions, alterations, and equivalents within the spirit and scope of the following appended claims.

What is claimed is:

1. An electrochemical cell comprising:
(i) a fuel electrode comprising a metal fuel; and
(ii) an oxidant electrode spaced from the fuel electrode, having a fuel electrode-facing side and an oxidant-facing side; and
(iii) a liquid ionically conductive medium for conducting ions between the fuel and oxidant electrodes to support electrochemical reactions at the fuel and oxidant electrodes;
the fuel electrode and the oxidant electrode being configured to, during discharge, oxidize the metal fuel at the fuel electrode and reduce a gaseous oxidant at the oxidant electrode to generate a discharge potential difference therebetween for application to a load; and
the oxidant electrode comprising:
an active layer configured to participate in the electrochemical reactions at the oxidant electrode;
a solvophobic layer between the oxidant-facing side and the active layer, the solvophobic layer configured to prevent permeation of the liquid ionically conductive medium therethrough, but permit permeation of the gaseous oxidant therethrough;
a reinforcement layer at the oxidant-facing side, configured to prevent a distortion of the solvophobic layer therethrough, towards the oxidant-facing side, the reinforcement layer being permeable to the gaseous oxidant.

2. The electrochemical cell of claim 1, wherein the oxidant electrode is an air electrode configured to absorb ambient air and reduce oxygen therein, such that the active layer, the solvophobic layer, and the reinforcement layer are air-permeable, and the gaseous oxidant is the oxygen within the ambient air.

3. The electrochemical cell of claim 2, wherein one or more of the solvophobic layer and the reinforcement layer comprise a fluoropolymer material.

4. The electrochemical cell of claim 3, wherein the fluoropolymer material comprises polytetrafluoroethylene.

5. The electrochemical cell of claim 2, wherein the reinforcement layer is also solvophobic to the ionically conductive medium.

6. The electrochemical cell of claim 2, wherein the reinforcement layer is electrically isolated from the active layer.

7. The electrochemical cell of claim 2, wherein a pore size of the reinforcement layer is approximately the same size or smaller than a pore size of the solvophobic layer.

8. The electrochemical cell of claim 2, wherein a pore size of the reinforcement layer is approximately less than 1 micrometer.

9. The electrochemical cell of claim 8, wherein the pore size of the reinforcement layer is approximately between 50 and 200 nanometers.

10. The electrochemical cell of claim 2, wherein the reinforcement layer comprises reinforcement material and a binder.

11. The electrochemical cell of claim 10, wherein the reinforcement material comprises carbon.

12. The electrochemical cell of claim 10, wherein the binder comprises a fluoropolymer material.

13. The electrochemical cell of claim 10, wherein the binder of the reinforcement layer forms at least a portion of the solvophobic layer.

14. The electrochemical cell of claim 2, further comprising a secondary reinforcement layer, such that the reinforcement layer and the secondary reinforcement layer surround the solvophobic layer.

15. The electrochemical cell of claim 14, wherein the secondary reinforcement layer and the reinforcement layer comprise a reinforcement material and a binder.

16. The electrochemical cell of claim 15, wherein the reinforcement material is carbon.

17. The electrochemical cell of claim 15, wherein the binder comprises a fluoropolymer material.

18. The electrochemical cell of claim 15, wherein the binder of the reinforcement layer and the secondary reinforcement layer forms at least a portion of the solvophobic layer.

19. The electrochemical cell of claim 2, further comprising a charging electrode selected from the group consisting of (a) the oxidant electrode, (b) a separate charging electrode spaced from the fuel and oxidant electrodes, and (c) a portion of the fuel electrode.

20. The electrochemical cell of claim 19, wherein the fuel electrode and the charging electrode are configured to, during re-charge, reduce a reducible species of the metal fuel to electrodeposit the metal fuel on the fuel electrode and oxidize an oxidizable species of the oxygen by application of a re-charge potential difference therebetween from a power source.

21. The electrochemical cell of claim 20, wherein the reducible species of the metal fuel comprises ions of zinc, iron, aluminum, magnesium, or lithium, and wherein the metal fuel is zinc, iron, aluminum, magnesium, or lithium.

22. The electrochemical cell of claim 2, wherein the liquid ionically conductive medium comprises an aqueous electrolyte solution.

23. The electrochemical cell system of claim 22, wherein the aqueous electrolyte solution comprises sulfuric acid, phosphoric acid, triflic acid, nitric acid, potassium hydroxide, sodium hydroxide, sodium chloride, potassium nitrate, or lithium chloride.

24. An oxidant electrode for an electrochemical cell utilizing a fuel electrode comprising a metal fuel and a liquid ionically conductive medium configured to conduct ions between the fuel electrode and the oxidant electrode to support electrochemical reactions at the fuel and oxidant electrodes, the oxidant electrode comprising:
an active layer configured to participate in electrochemical reactions with the fuel electrode;
a solvophobic layer between an oxidant-facing side of the oxidant electrode, and the active layer, the solvophobic layer configured to prevent permeation of the liquid ionically conductive medium therethrough, but permit permeation of a gaseous oxidant therethrough; and
a reinforcement layer at the oxidant-facing side, configured to prevent a distortion of the solvophobic layer therethrough, towards the oxidant-facing side, the reinforcement layer being permeable to the gaseous oxidant.

25. The oxidant electrode of claim 24, wherein the oxidant electrode is an air electrode configured to absorb ambient air and reduce oxygen therein, such that the active layer, the solvophobic layer, and the reinforcement layer are air-permeable, and the gaseous oxidant is the oxygen within the ambient air.

26. A method for assembling a reinforced oxidant electrode for an electrochemical cell comprising:
providing a solvophobic layer configured to prevent permeation of a liquid ionically conductive medium therethrough, but permit permeation of a gaseous oxidant therethrough;
applying an active layer to a first side of the solvophobic layer facing the liquid ionically conductive medium, the active layer being configured to participate in electrochemical reactions at the oxidant electrode; and
applying a reinforcement layer to a second side of the solvophobic layer facing the gaseous oxidant, the reinforcement layer being configured to prevent a distortion of the solvophobic layer therethrough, in a direction from the active layer to the reinforcement layer, the reinforcement layer being permeable to the gaseous oxidant.

27. The method of claim 26, further comprising applying a secondary reinforcement layer to the first side of the solvophobic layer, prior to applying the active layer, such that the active layer is applied to the secondary reinforcement layer, and the reinforcement layer and the secondary reinforcement layer surround the solvophobic layer.

28. The method of claim 27, wherein the secondary reinforcement layer and the reinforcement layer comprise a reinforcement material and a binder.

29. The method of claim 28, wherein the binder of the reinforcement layer and the secondary reinforcement layer forms at least a portion of the solvophobic layer.
